(19) United States
(12) Patent Application Publication
(10) Pub. No.: US 2024/0012208 A1
(43) Pub. Date: Jan. 11, 2024

(54) A PLUGGABLE CONNECTOR FOR USE IN AN OPTICAL WIRELESS COMMUNICATION SYSTEM

(71) Applicant: SIGNIFY HOLDING B.V., EINDHOVEN (NL)

(72) Inventors: MATTHIAS WENDT, Würselen (DE); ANDREAS FELIX ALFRED BLUSCHKE, EINDHOVEN (NL); CHRISTIAN JORDAN, VENLO (NL); DAVID DERRIEN, EINDHOVEN (NL)

(21) Appl. No.: 18/018,594

(22) PCT Filed: Aug. 20, 2021
(86) PCT No.: PCT/EP2021/073153

§ 371 Date: Jan. 30, 2023

(30) Foreign Application Priority Data
Aug. 31, 2020 (EP) 20193678.8

(51) Int. Cl. G02B 6/38; H04B 10/114; H04B 10/116

(52) U.S. Cl. CPC G02B 6/3869; H04B 10/1149; H04B 10/116; G02B 6/3897; H05B 47/195

(57) ABSTRACT

A pluggable connector is provided for use in an optical wireless communications, OWC, system. A main housing has an electrical connector for pluggable connection to a socket, with an optical transmitter and receive circuitry in the main housing. A carrier part has an adjustable orientation relative to the main housing and includes a (passive) optical output device for delivering an optical communications signal beam and an (active) optical receiver for receiving an optical communications signal beam. A flexible optical connector is provided between the optical transmitter and the optical output device and a flexible electrical connector is provided between the optical receiver and the receive circuitry. This provides a hybrid connection scheme between a movable optical carrier part and a static electrical part.

### FIELD OF THE INVENTION

This invention relates to optical wireless communication systems.

### BACKGROUND OF THE INVENTION

LiFi (Light Fidelity) is a new type of Optical Wireless Communication (OWC), which also includes Visible Light Communication (VLC). OWC (and hence LiFi and VLC) use light as a media of communication, for replacing cable wire (wireline) communication.

Light based communication offers the ability for high data rate communication, for example even exceeding 10 Gbit/s, for devices having a line of sight between them. This for example applies to a set of communicating devices within an office environment.

Known LiFi products rely on a grid of optical access points mounted in the ceiling. The beams of these access points are wide enough (and thereby have a large field of view and/or coverage area) to create an overlap with the neighboring access points at the level of the desks beneath. The receiving devices in such a system are typically located at the desks or are being handheld at a height close thereto.

For ease of installation, the grid of access points is for example aligned with the luminaire grid in the ceiling. Each access point in such an installation must reach (illuminate, in the case of visible light) several square meters and hence illuminates a significant conical area. Such installations may utilize illumination light for the downlink (towards the dongles and/or mobile devices) and may use infrared light for the uplink (towards the access point) so as not to disturb mobile device users. Alternatively, both downlink and uplink may utilize infrared light thereby at least partially disentangling the lighting and communication infrastructure.

To communicate with the access points, a dongle is connected to a user device such as a laptop or tablet. These dongles also emit a similar broad beam to be sure that at least one access point will receive the signal from the dongle. The beams of the access points and the dongles are fixed in direction, so no adjustment of the beam direction is required.

Each access point comprises a modem connected to one or multiple transceivers. The user devices connect to the access point via an optical link and they also comprise a modem connected to one or multiple transceivers.

The function of the modem is to handle the protocols (modulate and demodulate) for transmitting and receiving data over the visible or invisible light connection. The modem transmitter includes an optical frontend which transforms an electrical signal of the transmit data to an optical signal (for example using an LED) and the modem receiver transforms the optical signal to an electrical receive data signal (using a photodiode).

The invention relates in particular to the interconnection between the optical parts of a device (transmitter and receiver) and the electrical parts of such a device. LiFi systems are currently connected through Ethernet connections to an internet router or other kind of network infrastructure.

A modular approach for the various communication interfaces would be desirable, to enable simplified system integration. For example, a well-known modular interface for a socket of a network component is the so-called SFP (Small Form-Factor Pluggable) interface module. The SFP system is a 1 Gbps (SGMII) system and the SFP+ system is a 10 Gbps (XGMII) system. There are both intended to be considered part of the general SFP system in the description below.

A SFP transceiver is typically fully contained in a main housing (cage) which, when connected to a network component, is fixed inside network components such as network switches or routers.

A modified SFP connector for use in a LiFi system has for example been proposed in “Practical Considerations about LiFi Communications” or V. Manea et. al., Advanced Topics in Optoelectronics, Microelectronics and Nanotechnologies IX, 2018, Constanta, Romania, Proc. of SPIE Vol. 10977. The transmitter and receiver of the LiFi transceiver are wired to the SFP connector circuit board.

However, the LiFi system (and OWC systems more generally) requires setting of the beam direction to ensure line-of-sight with connection between end devices and good coverage of a target space. This becomes difficult to implement with existing pluggable connector designs.

WO2019/034864 discloses a pluggable connector with a rotatable member which carries the transmitter and receiver, to enable adjustment of the beam angle. However, the various connections introduce losses giving reduced performance.

### SUMMARY OF THE INVENTION

The invention is defined by the claims.

According to examples in accordance with an aspect of the invention, there is provided a pluggable connector for use in an optical wireless communications (OWC) system comprising:
a main housing having an electrical connector for pluggable connection to a socket;
an optical transmitter in the main housing;
a carrier part having an adjustable orientation relative to the main housing;
an optical output device mounted on the carrier part for delivering an optical communications signal beam, the optical output device comprising a passive optical component;
an optical receiver mounted on the carrier part for receiving an optical communications signal beam;
receive circuitry for processing the optical communications signal beam received by the optical receiver, located in the main housing; and
a flexible optical connector between the optical transmitter and the optical output device and a flexible electrical connector between the optical receiver and the receive circuitry.

This approach uses a flexible optical connector to the carrier part for the transmission channel. This connection is easy to implement with low signal loss. The optical transmitter (i.e. an electrical to optical converter like a light emitting diode (LED) or a vertical cavity surface-emitting laser (VCSEL)) is mounted in the main housing. For the receiver channel, an electrical connector is used, and the optical receiver (i.e. an optical to electrical converter like a photo diode) is provided at the carrier part. This makes the optical requirements easier to meet, in particular the collection of light from a wide viewing angle.

By “flexible” is meant that relative movement between the parts at the opposite ends is permitted. A flexible connector may be formed of rigid parts, e.g. sliding contacts, but still provide a flexible connection.

Thus, the arrangement provides an advantageous compromise between the electrical and optical connection requirements for the receive and transmit channels.

When the main housing, in case of an SFP or comparable housing, is inserted in a slot/cage of a network device, the carrier part may still be re-oriented, enabling re-direction of the optical output device and optical receiver, in spite of the main housing and the components therein being fixed inside the network device.

The optical output device for example comprises a lens. This functions as a passive component for relaying the already-generated optical signal.

The optical connector for example comprises an optical fiber. This may be a low cost plastic optical fiber, and it typically only needs to span a short length.

The pluggable connector may further comprise a signal preconditioning circuit mounted on the carrier part for processing the signal received by the optical receiver. Thus, part of the signal processing for the receive channel may be implemented in the carrier part.

The pluggable connector may further comprise an auxiliary power supply terminal for receiving electrical power additional to power received from the socket. In this way, the circuitry may have a greater power demand than the power supply delivered via the socket (e.g. an SFP socket).

In a first set of examples, the carrier part is pivotally mounted to the main housing. Thus, they together form a single unit, with an adjustable orientation of the carrier part relative to the main housing.

In a second set of examples, the carrier part is detachable from the main housing. This gives more freedom to position and orient the carrier part relative to the main housing. The main housing may for example be hidden from view and only the carrier part is exposed for the transmission and reception of optical signals.

In one arrangement, the carrier part is detachable from the main housing with the flexible optical connector and the flexible electrical connector attached to the carrier part. Thus, the connectors couple to, and detach from, the main housing.

In another arrangement, the carrier part is detachable from the main housing with the flexible optical connector and the flexible electrical connector attached to the main housing. Thus, the connectors couple to, and detach from, the carrier part.

In another arrangement, the flexible optical connector and the flexible electrical connector are detachable from both the carrier part and the main housing. Thus, the connectors may connect and disconnect at both ends.

The electrical connector is for example a connector for connecting to a small form factor pluggable (SFP) connector socket. Other sockets may be used such as an M.2 socket.

The invention also provides an optical wireless communication transmitting unit for transferring data to a receiving unit as an optical signal which is propagated over free space, comprising:
a printed circuit board arrangement carrying electrical components;
a socket mounted on the printed circuit board arrangement; and
the pluggable connector as defined above, with the electrical connector of the main housing plugged into the socket.

This for example defines the transmitting side of a LiFi communication system, for example access points mounted in a ceiling.

The printed circuit board arrangement may comprise one or more printed circuit boards. Thus, the socket and the electrical components may be on the same circuit board or on separate (connected) printed circuit boards.

The transmitting unit may comprise a lighting driver, wherein the electrical components comprise a lighting driver circuit. The transmitting unit (i.e. the lighting driver) may then further comprise a second socket for communication using the Ethernet protocol. Thus, the driver has a port for OWC as well as a port for connection to an internet router or other network infrastructure, e.g. over WiFi.

The invention also provides a luminaire comprising the transmitting unit defined above and a light source arrangement.

The invention also provides an optical wireless communication receiving unit for receiving data from a transmitting unit as an optical signal which is propagated over free space, comprising:
a printed circuit board carrying electrical components;
a socket mounted on the printed circuit board; and
the pluggable connector defined above, with the electrical connector of the main housing plugged into the socket.

This for example defines the receiving side of a LiFi communication system, for example user portable terminals.

The invention also provides an optical wireless communication system comprising a set of transmitting units as defined above and at least one receiving unit as defined above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a typical configuration of a LiFi system;

FIG. 2 shows in simplified form a block diagram of a pluggable connector in accordance with the invention;

FIG. 3 shows in schematic form two options for the connection between the optical frontend (the carrier part) and the main housing;

FIG. 4 shows a detailed example of a pluggable connector in accordance with the invention;

FIG. 5 shows a luminaire including a lighting driver with two network ports one for optical wireless communication and one for Ethernet communication;

FIG. 6 shows in schematic form the circuit components of a first example of such a luminaire.

FIG. 7 shows in schematic form the circuit components of a second example of such a luminaire.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a pluggable connector (e.g. SFP) for use in an optical wireless communications, OWC, system. A main housing has an electrical connector for pluggable connection to a socket, for example an edge connector, with an optical transmitter and receive circuitry in the main housing, as well as signal processing circuitry. A carrier part has an adjustable orientation relative to the main housing and includes a (passive) optical output device for delivering an optical communications signal beam and an (active) optical receiver for receiving an optical communications signal beam. A flexible optical connector is provided between the optical transmitter and the optical output device and a flexible electrical connector is provided between the optical receiver and the receive circuitry. This provides a hybrid connection scheme between a movable optical carrier part and a static electrical part.

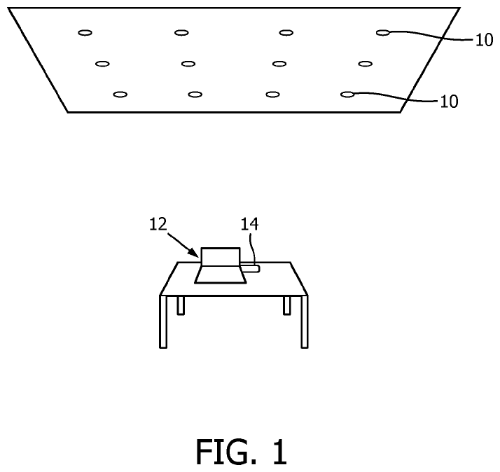

FIG. 1 shows a typical LiFi system with a set of transmitting units 10 forming a ceiling mounted infrastructure and a LiFi receiving unit 12. The transmitting units are known as access points (APs) and are preferably linked to a backbone, e.g. by means of a wired link such as an Ethernet link using a twisted pair cable or an Optical Fiber network allowing the APs and/or a global system controller to align, e.g. on handover. The receiving units are known as end devices (EDs).

Each AP contains a modem connected to one or multiple LiFi transceivers. The end devices can connect to an AP via an optical link. Each ED also contains a modem connected to one or multiple LiFi transceivers. The function of the LiFi-modem is to handle the physical layer (PHY) and media access control layer (MAC) protocols for transmitting and receiving data over the visible or invisible light connection.

The LiFi transceiver comprises a transmitter to transform an electrical signal of the modem's transmit data to an optical signal (e.g. via an LED, a VC SEL or laser diode) and to provide a receiver to transform an optical signal to an electrical of the modem's receive data (e.g. via a photodiode). The end device is for example implemented by a dongle 14 attached to a mobile device such as a laptop. Instead of retro-fitting, it is envisaged that the receiver functionality is ideally integrated with the mobile devices themselves, in this manner laptops, tablets, mobile phones and/or other devices may use optical communication without the need for a dongle. However, the present invention provides for an advantageous compromise between a detachable and an integrated LiFi solution.

The invention relates to the interface between the electrical components and the optical components of the system.

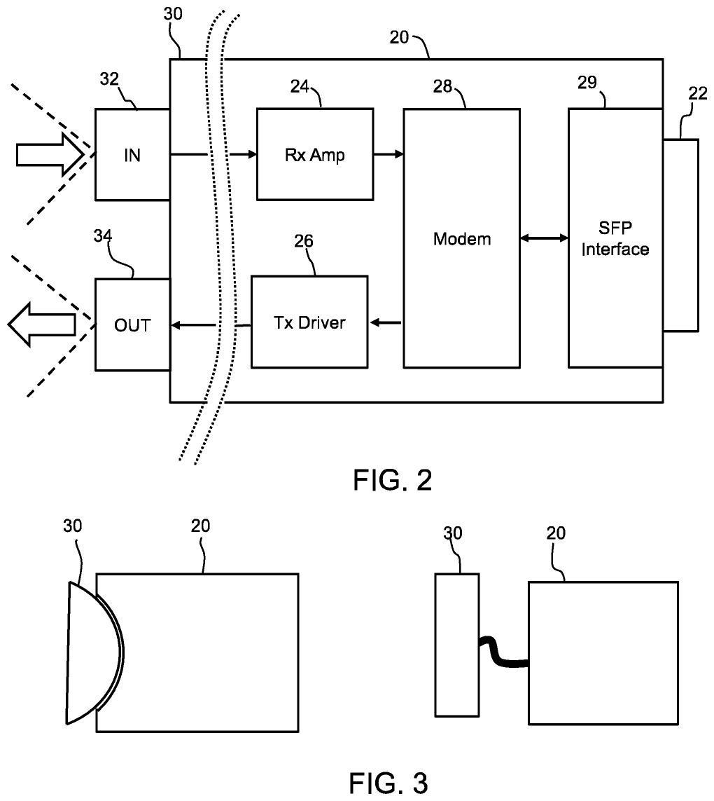

FIG. 2 shows in simplified form a block diagram of a pluggable connector in accordance with the invention.

The connector comprises a main housing 20 having an electrical connector 22 for pluggable connection to a socket. By way of example the electrical connector 22 is a small form factor pluggable (SFP) connector for connection to a SFP socket in particular the SFP edge connector.

A carrier part 30 has an adjustable orientation relative to the main housing 20.

The carrier part 30 comprises an optical input part 32 and an optical output part 34, and thus it provides the optical interface to the optical wireless communications channels. The details of the input and output parts are discussed further below.

Within the main housing 20, there is receive circuitry 24 for processing the optical communications signal beam received by the optical input part 32 and transmit circuitry 26 for generating the optical output data to be output by the optical output part. An OFDM modem 28 is also provided and a connection interface 29, e.g. an SFP interface. The connection interface meets the SFP interface conditions. This includes power supply conditions, the configuration of data channels and a management channel etc.

In this way, the optical frontend devices 32, 34 which define the optical axis for the OWC, e.g., LiFi, beam are contained in the carrier part 30. The separation between the main housing and the carrier part allows the carrier part to be directed facing the line of sight towards the OWC end devices or to cover a specified area of a room.

The components in the main housing 20 are fully inserted into an SFP cage of a network device. The carrier part 30 in turn is external to the cage.

The SFP system has a pluggable cage, which is a fixed void in which the non moveable main housing 20 of the device fits. At the back of the cage is a socket, in the form of an edge connector. The moveable carrier part 30 protrudes or extends beyond the socket cage, such that it can be aimed into the direction of LiFi serviceable area. There are standardized form factors for such voids, and the invention may be applied with any suitable design.

FIG. 3 shows in schematic form two options for the connection between the optical frontend (the carrier part 30) and the main housing 20.

The left image shows the carrier part 30 pivotably attached to the main housing 20 of the connector. The moveable carrier part for example protrudes from the connector cage when the main housing is fully inserted into the cage, in order to allow manipulation of the beam angle. The carrier part may be attached by means of a bendable or pivotable mounting or it may use spring and/or magnetic forces to attach to the main housing.

The interface between the carrier part and the main housing is for example a spherical surface. Thus, a spherical interface of the carrier part is provided over, and in contact with, with a spherical interface of the main housing. A spherical interface allows two-axis rotation (of course with limits to the allowable rotation angles) so that the optical axis may be adjusted to face any desired direction.

A light source providing a visible aiming light beam may be provided to assist with the adjustment. This may use the same connector from the main housing 20 to the movable carrier 30 or it may be mounted on the carrier. The visible beam is then indicative for the invisible IR beam.

A handle (not shown) is preferably provided to enable the main housing to be removed from the cage, optionally this same handle may be used to adjust the direction of the beam without accidentally touching the optical device surfaces. Optical covers as well as eject levers are also known to those skilled in the art of SFP module design. The carrier part may for example have an adjustment handle which is removed after the installation and beam aiming is complete.

The right image shows the carrier part 30 detached from the main housing 20 with a flexible connection between them (discussed below). A direct mechanical coupling between the carrier part and the main housing is thereby given up. Optionally the carrier part is not only detached, but the flexible connection may also be detachable. The carrier part thereby forms a detachable sub-module, and this may for example be fixed to a ceiling using brackets. The flexible connection for example allows the placement of the carrier part below a suspended ceiling, whereas the main housing, and the network component which has the SFP cage, are located above the suspended ceiling.

The invention provides a particular division of components between the carrier part and the main housing, and a particular connection between the two parts.

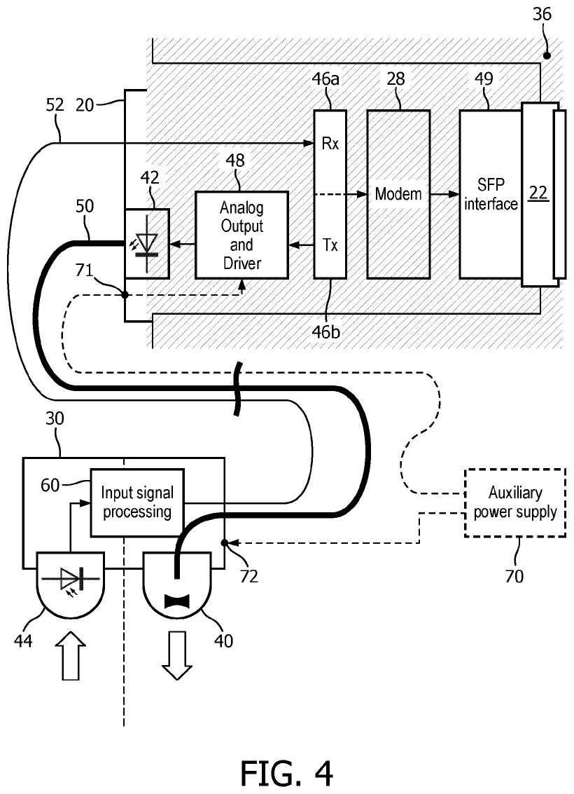

FIG. 4 shows a more detailed example of a pluggable connector in accordance with the invention. The main housing 20 is plugged into a cage with a socket, shown generally as 36.

FIG. 4 shows an example with a detached carrier part 30. The carrier part 30 includes a passive optical output device 40 such as a lens, for delivering the optical communications signal beam. A concave lens may be used at the termination of an optical fiber to widen the beam. Alternatively a holographic diffuser may be used. The electrical to optical conversion thus takes place in the main housing by means of an optical transmitter 42.

The optical fiber is for example one or more multimode optical fibers (MMF) or a plastic optical fiber (POF). A plastic optical fiber for example has a diameter of around 1 mm and a multimode optical fiber for example has a diameter of around 400 μm. A bundle of multimode optical fibers may be used.

The optical to electrical conversion for the receive channel takes place in the carrier part 30 by means of an optical receiver 44 for receiving an optical communications signal beam.

Receive circuitry 46a for processing the optical communications signal beam received by the optical receiver 44 is located in the main housing. There is corresponding transmit circuitry 46b. The modem 28 performs baseband processing.

The connection between the carrier part and the main housing is thus both electrical and optical. The flexible connection will typically have a length less than 1 m for example less than 50 cm, for example less than 30 cm, since it is typically only for connection from one (e.g. hidden) part of a luminaire to another (e.g. exposed) part of the luminaire. A flexible optical connector 50 is provided between the optical transmitter 42 and the optical output device 40 and a flexible electrical connector 52 is provided between the optical receiver 44 and the receive circuitry 46.

The flexible electrical connector comprises a cable, for example a twisted pair cable. For the alternative example of a fixed but pivotable carrier unit, the flexible electrical connection may instead be realized by means of flexible PCBs or sliding contacts.

The flexible electrical connector provides routing of the required supply power to the components of the carrier part as well as the electrical receive signal from the receiver 44.

The optical transmitter 42 is driven by an analog driver circuit 48 which is controlled by the transmit circuit 46b. The optical transmitter 42 comprises one or more LEDs or lasers (e.g. VCSELs) and the optical receiver 44 comprises one or multiple photodiodes. Depending on the modulation used; the optical transmitter 42 may also include a biasing stage, for example when using a bipolar OFDM signal so as to create a unipolar drive signal. When using a unipolar modulation technique a bias stage may not be required.

Collecting received light in an optical fiber from a wide viewing angle is challenging. Thus, the optical to electric conversion in the carrier part, and the resulting electrical connection, is preferred. The optical connection means the electrical transmission power to the transmitter 42 does not need to be conducted over a substantial distance. In this way, the requirement on wiring quality and electrical signal driving are relaxed. A high quality signal connection can be achieved using the optical connection to the passive optical output device.

FIG. 4 shows an example in which receive signal preconditioning is also carried out directly in the frontend carrier part 30 by means of the input signal processing module 60. This for example comprises a transimpedance (TIA) amplifier.

FIG. 4 also shows an auxiliary supply 70, for example for providing power to the input signal processing module 60 as well as to the driver 48 of the transmitter 42 if more than the available connector (e.g. SFP) power is required. The auxiliary power supply connects to one or more terminals 71,72 of the pluggable connector. The SFP power supply is power limited, for example in the range of a few Watts. Depending on the optical power required, the external power supply 70 may thus be needed for the transmit side. If twisted pair cabling is used, power injectors as are known from Power over Ethernet technology may be employed.

The carrier part may be fully detachable from the main housing (i.e. with the electrical and optical connections unplugged). Thus, there may be different designs of carrier part and different designs of main housing components, to enable a modular design and facilitate installation in different contexts.

The flexible optical connector and the flexible electrical connector may be attached to, and hence part of, the carrier part. Alternatively, the flexible optical connector and the flexible electrical connector may be attached to, and hence part of, the main housing.

The flexible optical connector and the flexible electrical connector may instead be detachable (unplugged) from both the carrier part and the main housing.

Fiber-optic connectors and electrical connectors are well known which are suitable for the various possible pluggable connections. For example, fiber optical pigtails may be used.

The connector provides bidirectional data transfer. However, there is typically a higher data rate downlink and a lower data rate uplink. A unit delivering the downlink data may be considered to be a transmitting unit and a unit receiving the downlink data may be considered to be a transmitting unit.

The pluggable connector described above may be used as part of such an optical wireless communication transmitting unit (e.g. an access point of a LiFi system, for delivering the downlink data) for transferring data to a receiving unit. The transmitting unit has a printed circuit board arrangement (of one of more circuit boards) carrying electrical components, and a socket, e.g. an SFP cage and edge connector, is provided on one of those circuit boards. The electrical connector of the pluggable connector is then plugged into the edge connector to provide the optical transmitter and receiver unit, for enabling OWC (e.g. LiFi) functionality.

Similarly, the pluggable connector described above may be used as part of such an optical wireless communication receiving unit (e.g. a LiFi receiver, for receiving the downlink data) for receiving data from a transmitting unit. The receiving unit again has a printed circuit board arrangement (of one of more circuit boards) carrying electrical components, and a socket, e.g. an SFP cage and edge connector, is provided on one of those circuit boards. The electrical connector of the pluggable connector is then plugged into the edge connector to provide the optical transmitter and receiver unit, for enabling OWC (e.g. LiFi) functionality.

The invention may be applied to a lighting driver.

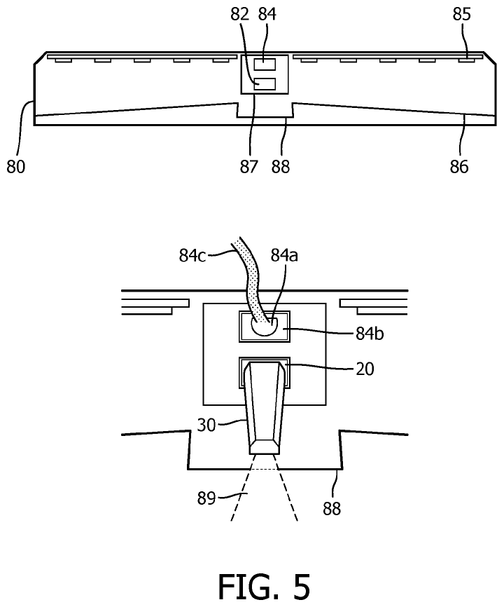

The top part of FIG. 5 shows a side-view of a luminaire 80 with two empty SFP cages 82, 84 (these may generally be considered to be connection sockets). One cage 84 can be used for an SFP module/transceiver for the Ethernet connection (to the Internet/WAN). The other cage 82 can be used for a second SFP module/transceiver for the LiFi-SFP as described above.

The pins of the edge connectors (which are located inside the SFP cages) are connected back-to-back.

There may be two separate cages or a double cage (side to side or one above the other). The Ethernet connection may be fiber based or copper based.

FIG. 5 also shows the light source arrangement in the form of LED modules and a diffusor 86. The luminaire includes a lighting driver 87 and a cover 88, for example having a removable cap or being translucent to the IR radiation used by the LiFi system. The lighting driver incorporates the two cages 82,84.

The enlarged part at the bottom of FIG. 5 shows the connections made to the cages 82,84. The LiFi SFP has the main housing 20 inserted into the cage and the projection carrier 30, which emits a LiFi transmission beam 89.

The network connection comprises a network plug 84a, SFP connector 84b and optical fiber 84c.

This provides a LiFi ready luminaire 80 comprising a lighting driver 87, with a transmitting unit plugged into the cage 82, as well as a (separate) light source arrangement for providing general and/or task lighting. This luminaire design allows mounting of the carrier part 30 on the luminaire surface and placement of the SFP cage, for receiving the main housing 20, in the luminaire. In this way, the SFP can be kept out of sight.

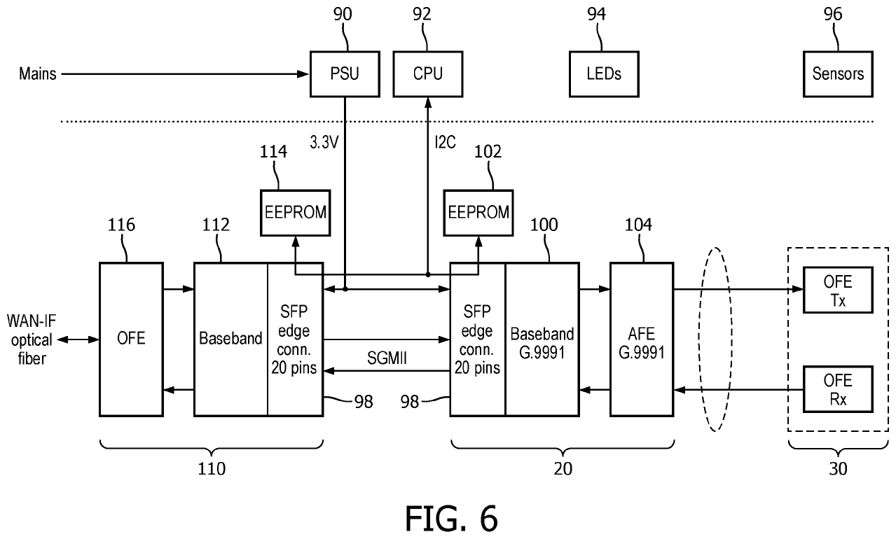

FIG. 6 shows in schematic form the circuit components of such a luminaire.

The luminaire comprises a power supply unit 90 (an AC/DC converter such as a switch mode power converter), main controller 92, light source arrangement 94 (LEDs) and optionally sensors 96 for example for automatic lighting control. These units represent the normal luminaire components.

The housing of the lighting driver has the two SFP cages described above. The SFP edge connectors 98 are shown in FIG. 6. In this way, the luminaire is prepared for future wireless applications, and hence may be considered to LiFi-ready, i.e. ready for future wireless access point applications. The empty SFP cages are for example implemented as part of the LED driver. Different SFP modules or transceivers may be fitted to the cages, depending on the intended application, such as optical fiber, Copper-based or wireless. The empty SFP cages are for example closed with dust covers:

The power supply unit 90 functions as the auxiliary supply discussed above. Thus, it couples a power supply voltage to the two cages.

The first cage 82 provides LiFi connectivity. The main housing 20 of a connected pluggable connector has a modem 100 as explained above, a memory 102, the LiFi interface 104 and the connector for connection to the edge connector. The remote carrier part 30 functions as the optical front end. The LiFi functionality is in this way split into two parts: the baseband part (the modem) and the optical frontend.

The remote carrier part 30 is for example positioned in a special hole or slot in the luminaire (which in certain luminaires may be termed the “Easysense-slot”) which slots are already used in luminaires for upgrading luminaires by adding presence or motion detection sensors. The SFP port of the LiFi-ready driver may in this way be conveniently positioned so that a covered hole may be available from which the optical frontend can protrude.

The second cage 84 provides Ethernet connectivity. In this example, a connected SFP transceiver 100 functions as a Wide Area Network interface 110. This example shows a standard optical SFP. Within the housing of the SFP connector is the modem 112, a memory 114, the optical front end 116 and the connector for connection to the edge connector. The Ethernet port is used for optical data connection to the luminaire.

In each case, the connection (called the SFP connector) to the edge connector is made by a PCB with 10 pins on each side.

In another example, a Power over Ethernet (PoE) based LED driver will only require a single SFP port for the LiFi connectivity, in that data connectivity is already provided through the PoE cabling.

FIG. 6 shows an example with back to back connections between the two edge connections. This may instead be implemented by a jumper.

The jumper connects all pins from the edge connector of the first SFP to the corresponding pins of the edge connector of the 2nd SFP, so they are bridged.

In some cases, it may be desirable to add an additional SFP together with a 3-Port-Ethernet switch. This may be used to connect luminaires to each other. This additional switch and the third SFP cage would not be integrated into the LED driver but would be added only on customer request.

To connect the interfaces (SGMIIs) of the three SFPs the jumper connection between the first and second SFPs is removed. The interface of the first SFP can then be connected to one port (SGMII port) of the 3-Port Ethernet switch and the interface of the second SFP can be connected to another port (SGMII) port of the 3-Port Ethernet switch. These connections can be realized with a new jumper.

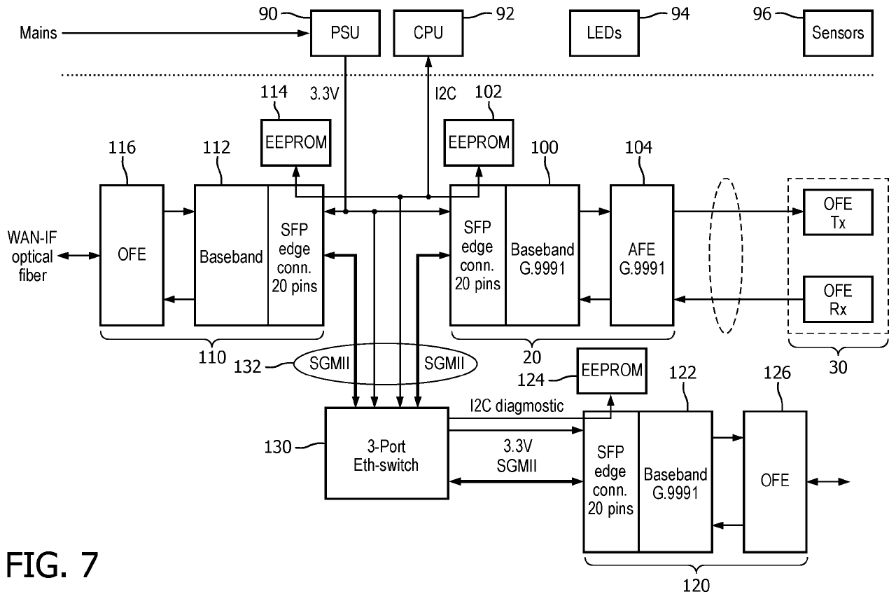

FIG. 7 shows this modification to the system of FIG. 6. A third second cage provides a LAN interface 120. Within the housing of the third SFP connector is the modem 122, a memory 124, an optical front end 126 (since this is example is based on optical connections between the luminaires over the LAN) and the connector for connection to the 3-Port switch 130. The 3-Port switch 130 connects to the two other edge connectors using the new jumper 132. The power supplies and digital diagnostic are also connected from the switch 130.

The function of a luminaire can in this way be extended step by step, with two SFPs (with a closed jumper between them) and with three SFPs and a 3-Port switch 130 with the new jumper 132. The luminaire can be connected to the Internet, and a wireless access point can be connected to the luminaire. The Internet signal can be forwarded from one luminaire to the next, so that a flexible connection system can be provided.

There may be multiple carrier parts for a single main housing, for example connected together e.g. in a star connection or a daisy chain.

The example above is based on a SFP connector. However, depending on the form factor and space available, other connection types may be used. For example the interface may be based on the M.2 system. Other connector types include QSFP+.

The SFP connector may include heat sink features, not described above.

An example has been given above for the integration of LiFi to a luminaire, but the invention applies more generally to the implementation of Optical Wireless Communication with any network equipment such as consumer internet routers.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A pluggable connector for use in an optical wireless communications system comprising:
a main housing having an electrical connector for pluggable connection to a socket;
an optical transmitter in the main housing;
a carrier part having an adjustable orientation relative to the main housing;
an optical output device mounted on the carrier part for delivering an optical communications signal beam, the optical output device comprising a passive optical component;
an optical receiver mounted on the carrier part for receiving an optical communications signal beam;
receive circuitry for processing the optical communications signal beam received by the optical receiver, located in the main housing; and
a flexible optical connector between the optical transmitter and the optical output device and a flexible electrical connector between the optical receiver and the receive circuitry.

2. The pluggable connector of claim 1, wherein the optical output device comprises a lens.

3. The pluggable connector of claim 1, wherein the flexible optical connector comprises an optical fiber.

4. The pluggable connector of claim 1, further comprising a signal preconditioning circuit mounted on the carrier part for pre-processing the signal received by the optical receiver prior to the processing by the receive circuitry.

5. The pluggable connector of claim 1, further comprising an auxiliary power supply terminal receiving electrical power additional to power received from the socket.

6. The pluggable connector of claim 1, wherein the carrier part is pivotally mounted to the main housing.

7. The pluggable connector of claim 1, wherein the carrier part is detachable from the main housing.

8. The pluggable connector claim 7, wherein:
the carrier part is detachable from the main housing with the flexible optical connector and the flexible electrical connector attached to the carrier part; or
the carrier part is detachable from the main housing with the flexible optical connector and the flexible electrical connector attached to the main housing; or
the flexible optical connector and the flexible electrical connector are detachable from both the carrier part and the main housing.

9. The pluggable connector of claim 1, wherein the electrical connector is a connector for connecting to a small form factor pluggable connector socket.

10. An optical wireless communication transmitting unit for transferring data to a receiving unit as an optical signal which is propagated over free space, comprising:
a printed circuit board arrangement carrying electrical components;
a socket mounted on the printed circuit board arrangement; and
a pluggable connector, the pluggable connector comprising:
a main housing (20) having an electrical connector (22) for pluggable connection to a socket (36);
an optical transmitter (42) in the main housing;
a carrier part (30) having an adjustable orientation relative to the main housing;
an optical output device (40) mounted on the carrier part for delivering an optical communications signal beam, the optical output device comprising a passive optical component;
an optical receiver (44) mounted on the carrier part for receiving an optical communications signal beam;
receive circuitry (46a) for processing the optical communications signal beam received by the optical receiver, located in the main housing; and
a flexible optical connector (50) between the optical transmitter and the optical output device and a flexible electrical connector (52) between the optical receiver and the receive circuitry,
wherein the electrical connector of the main housing is for plugging into the socket.

11. The transmitting unit of claim 10, comprising a lighting driver, wherein the electrical components comprise a lighting driver circuit.

12. The transmitting unit of claim 11, further comprising a second socket for communication using the Ethernet protocol.

13. A luminaire comprising the transmitting unit of claim 10 and a light source arrangement.

14. An optical wireless communication receiving unit for receiving data from a transmitting unit as an optical signal which is propagated over free space, comprising:
a printed circuit board carrying electrical components;
a socket mounted on the printed circuit board; and
the pluggable connector of claim 1, with the electrical connector of the main housing plugged into the socket.

15. An optical wireless communication system comprising a set of optical wireless communication transmitting units for transferring data to a receiving unit as an optical signal which is propagated over free space, each of the transmitting units comprising:
a printed circuit board arrangement carrying electrical components;
a socket (82) mounted on the printed circuit board arrangement; and
the a pluggable connector of any one of claims 1 to 9, the pluggable connector comprising:
a main housing (20) having an electrical connector (22) for pluggable connection to a socket (36);
an optical transmitter (42) in the main housing;
a carrier part (30) having an adjustable orientation relative to the main housing;
an optical output device (40) mounted on the carrier part for delivering an optical communications signal beam, the optical output device comprising a passive optical component;
an optical receiver (44) mounted on the carrier part for receiving an optical communications signal beam;
receive circuitry (46a) for processing the optical communications signal beam received by the optical receiver, located in the main housing; and
a flexible optical connector (50) between the optical transmitter and the optical output device and a flexible electrical connector (52) between the optical receiver and the receive circuitry,
wherein the electrical connector of the main housing is for plugging into the socket, and
at least one receiving unit of claim 14.
